(19) United States
(12) Patent Application Publication
(10) Pub. No.: US 2003/0087597 A1
(43) Pub. Date: May 8, 2003

(54) Manufacturing system, control apparatus and control method therefor, control program, and storage medium

(75) Inventor: Hiroki Ohkouchi, Tochigi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/285,427

(22) Filed: Nov. 1, 2002

(30) Foreign Application Priority Data
Nov. 7, 2001 (JP) 2001-342119

(51) Int. Cl. B01L 1/04; F24F 7/007

(52) U.S. Cl. 454/187; 454/229

(57) ABSTRACT

An object of this invention is to reduce the capacity of an air pressure supply equipment in a semiconductor manufacturing factory without decreasing the productivity of a manufacturing system. To achieve this object, the manufacturing system includes a plurality of processing apparatuses (1, 2, 3), an air pressure supply apparatus (4) which supplies a gas pressure to the plurality of processing apparatuses, and a control apparatus (7) for controlling the plurality of processing apparatuses. The control apparatus creates operation schedules for the plurality of processing apparatuses on the basis of temporal change information of an air pressure consumption amount corresponding to the operation order of each of the plurality of processing apparatuses so as to prevent the sum of air pressure consumption amounts of the plurality of processing apparatuses from exceeding the air pressure supply ability of the air pressure supply apparatus.

### FIELD OF THE INVENTION

The present invention relates to a manufacturing system, a control apparatus and control method therefor, a control program, and a storage medium, which are effective in a semiconductor manufacturing apparatus serving as a processing apparatus.

### BACKGROUND OF THE INVENTION

Semiconductor manufacturing apparatuses perform control such as vibration damping/vibration suppression control, object chuck, object flotation, and object driving by using gas pressure (to be simply referred to as air pressure hereinafter).

Advanced apparatuses require larger air pressure amounts. The air pressure amount is predicted to further increase along with ceaseless demands for higher performance.

A semiconductor manufacturing factory where many semiconductor manufacturing apparatuses are installed to execute semiconductor production requires an air pressure supply equipment capable of supplying air pressure amounts requested by all the installed apparatuses. The air pressure supply equipment becomes very large in a large-scale semiconductor manufacturing factory where several ten or several hundred semiconductor manufacturing apparatuses are aligned in the production line.

The air pressure consumption amount of the semiconductor manufacturing apparatus changes depending on the operation state such as activation, the standby state, or processing. An example of this difference is represented by the air pressure consumption amount profile of FIG. 2 which shows the air pressure consumption amount in each operation state. The air pressure consumption amount profile represents the maximum value of each processing unit obtained by measuring the operation air pressure consumption amount of one apparatus or those of a plurality of apparatuses of the same type a plurality of number of times by any air pressure consumption amount measurement means. In activation, a higher air pressure is required for initial filling or initial driving of each portion. In the standby state, the apparatus stands by with the minimum maintenance air pressure. In processing, the air pressure consumption amount changes depending on the processing contents.

Apparatuses are assumed to operate independently. Of the air pressure consumption amount profiles of apparatuses, the maximum or similar profile exhibits an air pressure amount requested to the factory equipment.

In the example of the air pressure consumption amount profile of FIG. 2 described above, the maximum air pressure amount in activation must be 10 times larger than that in the standby state, but the ratio of the time to the total operation time is low. The next air pressure consumption section corresponds to processing A in which the air pressure consumption amount must be six times larger than that in the standby state and the ratio of the time to the processing time including the average standby time is about 20%.

When the activation air pressure consumption amount is required as a requested air pressure amount per apparatus to the factory equipment, the factory equipment needs an air pressure supply equipment which supplies an air pressure amount about 10 times larger than the average air pressure amount used in all the apparatuses. Even if the air pressure amount used in processing A is required as a requested air pressure amount, the factory equipment needs an equipment which supplies an air pressure amount about five times larger than the average air pressure used. In this case, if half or more of all the apparatuses simultaneously use their activation air pressure amounts, the air pressure supply amount runs short.

In general, the air pressure consumption amount of the apparatus is not constant within the operation time, and the difference between the maximum air pressure consumption amount and the average air pressure consumption amount is large. When the air pressure supply equipment is prepared for the maximum air pressure consumption amount, the air pressure equipment becomes idle for most of the time. If the air pressure supply equipment is prepared for the average air pressure consumption amount and the peaks of the air pressure consumption amounts of respective apparatuses accidentally coincide with each other, the air pressure may fail to be supplied.

Semiconductor manufacturing apparatuses have recently increased their necessary electric energy as their performance is improved. For example, one semiconductor exposure apparatus requires a large power of 50 kVA, which is twice the power of an apparatus five years ago. The necessary power is predicted to increase more and more for continuous demands for higher performance.

In a semiconductor manufacturing factory where many semiconductor manufacturing apparatuses are installed to execute semiconductor production requires a power supply equipment capable of supplying power requested by all the installed apparatuses. The power supply equipment becomes very large in a large-scale semiconductor manufacturing factory where several ten or several hundred semiconductor manufacturing apparatuses are aligned in the production line.

The power consumption of the semiconductor manufacturing apparatus changes depending on the operation state such as activation, the standby state, or processing. An example of this difference is represented by the power consumption profile of FIG. 8 which shows the power consumption in each operation state. The power consumption profile represents the maximum value of each processing unit obtained by measuring the operation power consumption of one apparatus or those of a plurality of apparatuses of the same type a plurality of number of times by any power consumption measurement means. In activation, a larger power is required for power supply to a charging type component at each portion or initial driving of a driving component. In the standby state, the apparatus stands by with the minimum maintenance power. In processing, the power consumption changes depending on the processing contents.

Apparatuses are assumed to operate independently. Of the power consumption profiles of apparatuses, the maximum or similar profile exhibits a power requested to the factory equipment.

In the example of the power consumption profile of FIG. 8, the maximum power in activation must be 10 times larger than that in the standby state, but the ratio of the time to the total operation time is low. The next power consumption section corresponds to processing A in which the power consumption must be six times larger than that in the standby state and the ratio of the time to the processing time including the average standby time is about 20%.

When the activation power consumption is required as a requested power per apparatus to the factory equipment, the factory equipment needs a power supply equipment which supplies power about 10 times larger than the average power of all the apparatuses. Even if power used in processing A is required as a requested power, the factory equipment needs an equipment which supplies power about five times larger than the average power. In this case, if half or more of all the apparatuses simultaneously use their activation powers, the power supply amount may run short to stop the power supply.

A huge storage battery apparatus is necessary to prepare, as a factory equipment, a power buffering equipment for absorbing variations in power consumption profile, resulting in a high equipment cost.

In general, the power consumption of the apparatus is not constant within the operation time, and the difference between the maximum power consumption and the average power consumption is large. When the power supply equipment is prepared for the maximum power consumption, the power equipment becomes idle for most of the time. If the power supply equipment is prepared for the average power and the peak powers of respective apparatuses accidentally coincide with each other, the power supply may run short.

### SUMMARY OF THE INVENTION

The present invention has been made to overcome the conventional drawbacks, and has as its object to reduce the capacity of an air pressure supply equipment in a semiconductor manufacturing factory without decreasing the productivity of a manufacturing system.

It is another object of the present invention to provide optimal productivity corresponding to the supply ability of the air pressure supply equipment in the semiconductor manufacturing factory.

It is still another object of the present invention to reduce the capacity of a power supply equipment in the semiconductor manufacturing factory without decreasing the productivity of the manufacturing system.

It is still another object of the present invention to provide optimal productivity corresponding to the supply ability of the power supply equipment in the semiconductor manufacturing factory.

To solve the above problems and achieve the above objects, a manufacturing system according to the first aspect of the present invention has the following arrangement.

That is, there is provided a manufacturing system comprising a plurality of processing apparatuses, an air pressure supply apparatus which supplies a gas pressure to the plurality of processing apparatuses, and a control apparatus for controlling the plurality of processing apparatuses, wherein the control apparatus creates operation schedules for the plurality of processing apparatuses on the basis of temporal change information of an air pressure consumption amount corresponding to an operation order of each of the plurality of processing apparatuses so as to prevent a sum of air pressure consumption amounts of the plurality of processing apparatuses from exceeding an air pressure supply ability of the air pressure supply apparatus.

A manufacturing system control apparatus according to the first aspect of the present invention has the following arrangement.

That is, there is provided a control apparatus for controlling a manufacturing system having a plurality of processing apparatuses, and an air pressure supply apparatus which supplies a gas pressure to the plurality of processing apparatuses, wherein the control apparatus creates operation schedules for the plurality of processing apparatuses on the basis of temporal change information of an air pressure consumption amount corresponding to an operation order of each of the plurality of processing apparatuses so as to prevent a sum of air pressure consumption amounts of the plurality of processing apparatuses from exceeding an air pressure supply ability of the air pressure supply apparatus.

A manufacturing system control method according to the first aspect of the present invention has the following steps.

That is, there is provided a control method of controlling a manufacturing system having a plurality of processing apparatuses, and an air pressure supply apparatus which supplies a gas pressure to the plurality of processing apparatuses, comprising creating operation schedules for the plurality of processing apparatuses on the basis of temporal change information of an air pressure consumption amount corresponding to an operation order of each of the plurality of processing apparatuses so as to prevent a sum of air pressure consumption amounts of the plurality of processing apparatuses from exceeding an air pressure supply ability of the air pressure supply apparatus, and operating the plurality of processing apparatuses on the basis of the created operation schedules.

A manufacturing system according to the second aspect of the present invention has the following arrangement.

That is, there is provided a manufacturing system comprising a plurality of processing apparatuses, an air pressure supply apparatus which supplies a gas pressure to the plurality of processing apparatuses, a control apparatus for controlling the plurality of processing apparatuses, and detection means for detecting an air pressure consumption amount of each of the plurality of processing apparatuses, wherein the control apparatus calculates a usable air pressure amount on the basis of air pressure consumption amount information of the processing apparatus detected by the detection means and air pressure supply ability information of the air pressure supply apparatus, and notifies the processing apparatus of the usable air pressure amount.

A manufacturing system control apparatus according to the second aspect of the present invention has the following arrangement.

That is, there is provided a control apparatus for controlling a manufacturing system having a plurality of processing apparatuses, and an air pressure supply apparatus which supplies a gas pressure to the plurality of processing apparatuses, wherein the control apparatus detects an air pressure consumption amount of each of the plurality of processing apparatuses, calculates a usable air pressure amount on the basis of detected air pressure consumption amount information of the processing apparatus and air pressure supply ability information of the air pressure supply apparatus, and notifies the processing apparatus of the usable air pressure amount.

A manufacturing system control method according to the second aspect of the present invention has the following steps.

That is, there is provided a control method of controlling a manufacturing system having a plurality of processing apparatuses, and an air pressure supply apparatus which supplies a gas pressure to the plurality of processing apparatuses, comprising detecting an air pressure consumption amount of each of the plurality of processing apparatuses, calculating a usable air pressure amount on the basis of detected air pressure consumption amount information of the processing apparatus and air pressure supply ability information of the air pressure supply apparatus, and notifying the processing apparatus of the usable air pressure amount.

A manufacturing system according to the third aspect of the present invention has the following arrangement.

That is, there is provided a manufacturing system comprising a plurality of processing apparatuses, an air pressure supply apparatus which supplies a gas pressure to the plurality of processing apparatuses, and communication means for allowing communication between the plurality of processing apparatuses, wherein each of the plurality of processing apparatuses comprises detection means for detecting an air pressure consumption amount of the processing apparatus, notification means for notifying the remaining processing apparatuses via the communication means of the detected air pressure consumption amount, and control means for controlling operation of the processing apparatus on the basis of pieces of air pressure consumption amount information from the remaining processing apparatuses and air pressure supply ability information of the air pressure supply apparatus so as to prevent a sum of air pressure consumption amounts of the plurality of processing apparatuses from exceeding an air pressure supply ability of the air pressure supply apparatus.

A manufacturing system control method according to the third aspect of the present invention has the following steps.

That is, there is provided a control method of controlling a manufacturing system having a plurality of processing apparatuses, an air pressure supply apparatus which supplies a gas pressure to the plurality of processing apparatuses, and communication means for allowing communication between the plurality of processing apparatuses, comprising causing each of the plurality of processing apparatuses to detect an air pressure consumption amount of the processing apparatus, to notify the remaining processing apparatuses via the communication means of the detected air pressure consumption amount, and to control operation of the processing apparatus on the basis of pieces of air pressure consumption amount information from the remaining processing apparatuses and air pressure supply ability information of the air pressure supply apparatus so as to prevent a sum of air pressure consumption amounts of the plurality of processing apparatuses from exceeding an air pressure supply ability of the air pressure supply apparatus.

A manufacturing system according to the fourth aspect of the present invention has the following arrangement.

That is, there is provided a manufacturing system comprising a plurality of processing apparatuses, a power supply apparatus which supplies power to the plurality of processing apparatuses, and a control apparatus for controlling the plurality of processing apparatuses, wherein the control apparatus creates operation schedules for the plurality of processing apparatuses on the basis of temporal change information of a power consumption corresponding to an operation order of each of the plurality of processing apparatuses so as to prevent a sum of power consumptions of the plurality of processing apparatuses from exceeding a power supply ability of the power supply apparatus.

A manufacturing system control apparatus according to the fourth aspect of the present invention has the following arrangement.

That is, there is provided a control apparatus for controlling a manufacturing system having a plurality of processing apparatuses, and a power supply apparatus which supplies power to the plurality of processing apparatuses, wherein the control apparatus creates operation schedules for the plurality of processing apparatuses on the basis of temporal change information of a power consumption corresponding to an operation order of each of the plurality of processing apparatuses so as to prevent a sum of power consumptions of the plurality of processing apparatuses from exceeding a power supply ability of the power supply apparatus.

A manufacturing system control method according to the fourth aspect of the present invention has the following steps.

That is, there is provided a control method of controlling a manufacturing system having a plurality of processing apparatuses, and a power supply apparatus which supplies power to the plurality of processing apparatuses, comprising creating operation schedules for the plurality of processing apparatuses on the basis of temporal change information of a power consumption corresponding to an operation order of each of the plurality of processing apparatuses so as to prevent a sum of power consumptions of the plurality of processing apparatuses from exceeding a power supply ability of the power supply apparatus, and operating the plurality of processing apparatuses on the basis of the created operation schedules.

A manufacturing system according to the fifth aspect of the present invention has the following arrangement.

That is, there is provided a manufacturing system comprising a plurality of processing apparatuses, a power supply apparatus which supplies power to the plurality of processing apparatuses, a control apparatus for controlling the plurality of processing apparatuses, and detection means for detecting a power consumption of each of the plurality of processing apparatuses, wherein the control apparatus calculates a usable power on the basis of power consumption information of the processing apparatus detected by the detection means and power supply ability information of the power supply apparatus, and notifies the processing apparatus of the usable power.

A manufacturing system control apparatus according to the fifth aspect of the present invention has the following arrangement.

That is, there is provided a control apparatus for controlling a manufacturing system having a plurality of processing apparatuses, and a power supply apparatus which supplies power to the plurality of processing apparatuses, wherein the control apparatus detects a power consumption of each of the plurality of processing apparatuses, calculates a usable power on the basis of detected power consumption information of the processing apparatus and power supply ability information of the power supply apparatus, and notifies the processing apparatus of the usable power.

A manufacturing system control method according to the fifth aspect of the present invention has the following steps.

That is, there is provided a control method of controlling a manufacturing system having a plurality of processing apparatuses, and a power supply apparatus which supplies power to the plurality of processing apparatuses, comprising detecting a power consumption of each of the plurality of processing apparatuses, calculating a usable power on the basis of detected power consumption information of the processing apparatus and power supply ability information of the power supply apparatus, and notifying the processing apparatus of the usable power.

A manufacturing system according to the sixth aspect of the present invention has the following arrangement.

That is, there is provided a manufacturing system comprising a plurality of processing apparatuses, a power supply apparatus which supplies power to the plurality of processing apparatuses, and communication means for allowing communication between the plurality of processing apparatuses, wherein each of the plurality of processing apparatuses comprises detection means for detecting a power consumption of the processing apparatus, notification means for notifying the remaining processing apparatuses via the communication means of the detected power consumption, and control means for controlling operation of the processing apparatus on the basis of pieces of power consumption information from the remaining processing apparatuses and power supply ability information of the power supply apparatus so as to prevent a sum of power consumptions of the plurality of processing apparatuses from exceeding a power supply ability of the power supply apparatus.

A manufacturing system control method according to the sixth aspect of the present invention has the following steps.

That is, there is provided a control method of controlling a manufacturing system having a plurality of processing apparatuses, a power supply apparatus which supplies power to the plurality of processing apparatuses, and communication means for allowing communication between the plurality of processing apparatuses, comprising causing each of the plurality of processing apparatuses to detect a power consumption of the processing apparatus, to notify the remaining processing apparatuses via the communication means of the detected power consumption, and to control operation of the processing apparatus on the basis of pieces of power consumption information from the remaining processing apparatuses and power supply ability information of the power supply apparatus so as to prevent a sum of power consumptions of the plurality of processing apparatuses from exceeding a power supply ability of the power supply apparatus.

A manufacturing system according to the seventh aspect of the present invention has the following arrangement.

That is, there is provided a manufacturing system comprising a plurality of processing apparatuses, a utility supply apparatus which supplies a utility to the plurality of processing apparatuses, and a control apparatus for controlling the plurality of processing apparatuses, wherein the control apparatus creates operation schedules for the plurality of processing apparatuses on the basis of temporal change information of a utility consumption amount corresponding to an operation order of each of the plurality of processing apparatuses so as to prevent a sum of utility consumption amounts of the plurality of processing apparatuses from exceeding a utility supply ability of the utility supply apparatus.

A manufacturing system control apparatus according to the seventh aspect of the present invention has the following arrangement.

That is, there is provided a control apparatus for controlling a manufacturing system having a plurality of processing apparatuses, and a utility supply apparatus which supplies a utility to the plurality of processing apparatuses, wherein the control apparatus creates operation schedules for the plurality of processing apparatuses on the basis of temporal change information of a utility consumption amount corresponding to an operation order of each of the plurality of processing apparatuses so as to prevent a sum of utility consumption amounts of the plurality of processing apparatuses from exceeding a utility supply ability of the utility supply apparatus.

A manufacturing system control method according to the seventh aspect of the present invention has the following steps.

That is, there is provided a control method of controlling a manufacturing system having a plurality of processing apparatuses, and a utility supply apparatus which supplies a utility to the plurality of processing apparatuses, comprising creating operation schedules for the plurality of processing apparatuses on the basis of temporal change information of a utility consumption amount corresponding to an operation order of each of the plurality of processing apparatuses so as to prevent a sum of utility consumption amounts of the plurality of processing apparatuses from exceeding a utility supply ability of the utility supply apparatus, and operating the plurality of processing apparatuses on the basis of the created operation schedules.

A manufacturing system according to the eighth aspect of the present invention has the following arrangement.

That is, there is provided a manufacturing system comprising a plurality of processing apparatuses, a utility supply apparatus which supplies a utility to the plurality of processing apparatuses, a control apparatus for controlling the plurality of processing apparatuses, and detection means for detecting a utility consumption amount of each of the plurality of processing apparatuses, wherein the control apparatus calculates a usable utility amount on the basis of utility consumption amount information of the processing apparatus detected by the detection means and utility supply ability information of the utility supply apparatus, and notifies the processing apparatus of the usable utility amount.

A manufacturing system control apparatus according to the eighth aspect of the present invention has the following arrangement.

That is, there is provided a control apparatus for controlling a manufacturing system having a plurality of processing apparatuses, and a utility supply apparatus which supplies a utility to the plurality of processing apparatuses, wherein the control apparatus detects a utility consumption amount of each of the plurality of processing apparatuses, calculates a usable utility amount on the basis of detected utility consumption amount information of the processing apparatus and utility supply ability information of the utility supply apparatus, and notifies the processing apparatus of the usable utility amount.

A manufacturing system control method according to the eighth aspect of the present invention has the following steps.

That is, there is provided a control method of controlling a manufacturing system having a plurality of processing apparatuses, and a utility supply apparatus which supplies a utility to the plurality of processing apparatuses, comprising detecting a utility consumption amount of each of the plurality of processing apparatuses, calculating a usable utility amount on the basis of detected utility consumption amount information of the processing apparatus and utility supply ability information of the utility supply apparatus, and notifying the processing apparatus of the usable utility amount.

A manufacturing system according to the ninth aspect of the present invention has the following arrangement.

That is, there is provided a manufacturing system comprising a plurality of processing apparatuses, a utility supply apparatus which supplies a utility to the plurality of processing apparatuses, and communication means for allowing communication between the plurality of processing apparatuses, wherein each of the plurality of processing apparatuses comprises detection means for detecting a utility consumption amount of the processing apparatus, notification means for notifying the remaining processing apparatuses via the communication means of the detected utility consumption amount, and control means for controlling operation of the processing apparatus on the basis of pieces of utility consumption amount information from the remaining processing apparatuses and utility supply ability information of the utility supply apparatus so as to prevent a sum of utility consumption amounts of the plurality of processing apparatuses from exceeding a utility supply ability of the utility supply apparatus.

A manufacturing system control method according to the ninth aspect of the present invention has the following steps.

That is, there is provided a control method of controlling a manufacturing system having a plurality of processing apparatuses, a utility supply apparatus which supplies a utility to the plurality of processing apparatuses, and communication means for allowing communication between the plurality of processing apparatuses, comprising causing each of the plurality of processing apparatuses to detect a utility consumption amount of the processing apparatus, to notify the remaining processing apparatuses via the communication means of the detected utility consumption amount, and to control operation of the processing apparatus on the basis of pieces of utility consumption amount information from the remaining processing apparatuses and utility supply ability information of the utility supply apparatus so as to prevent a sum of utility consumption amounts of the plurality of processing apparatuses from exceeding a utility supply ability of the utility supply apparatus.

A control program according to the present invention has the following processing.

That is, the control program causes a computer to execute any one of the above-described control methods.

A storage medium according to the present invention has the following program.

That is, the storage medium computer-readably stores any one of the above-described control programs.

Other objects and advantages besides those discussed above shall be apparent to those skilled in the art from the description of a preferred embodiment of the invention which follows. In the description, reference is made to accompanying drawings, which form a part hereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a block diagram showing a semiconductor manufacturing system according to the first embodiment of the present invention;

FIG. 2 is a graph showing the air pressure consumption amount profile of a semiconductor manufacturing apparatus;

FIG. 3 is a graph showing peak models A and B created from the air pressure consumption amount profile;

FIG. 4 is a graph showing an apparatus control schedule and total air pressure consumption amount using the peak model;

FIG. 5 is a graph showing an apparatus control schedule and total air pressure consumption amount using the air pressure consumption amount profile;

FIG. 6 is a block diagram showing a semiconductor manufacturing system according to the third example of the first embodiment;

FIG. 7 is a block diagram showing a semiconductor manufacturing system according to the second embodiment of the present invention;

FIG. 8 is a graph showing the power consumption profile of a semiconductor manufacturing apparatus;

FIG. 9 is a graph showing peak models A and B created from the power consumption profile;

FIG. 10 is a graph showing an apparatus control schedule and total power consumption using the peak model;

FIG. 11 is a graph showing an apparatus control schedule and total power consumption using the power consumption profile; and

FIG. 12 is a block diagram showing a semiconductor manufacturing system according to the third example of the second embodiment.

### DETAILED DESCRIPTION OF THE PREFERRED EMBODIMENTS

Preferred embodiments of the present invention will be described below.

In this specification, resources such as gas pressure, power, and water supplied from a factory equipment to a processing apparatus will be generally called “(factory) utility”.

(First Embodiment)

The outline of the first embodiment will be explained.

In most large-scale semiconductor manufacturing factories which house many semiconductor manufacturing apparatuses, a so-called on-line equipment which connects a host computer and many semiconductor manufacturing apparatuses via a communication means such as a LAN is installed to perform centralized information management of the semiconductor manufacturing apparatuses.

The first embodiment is characterized by the following methods using the on-line equipment.

(1) Centralized Control by Host Computer

The air pressure consumption amount profiles of respective apparatuses and the air pressure supply ability of a factory equipment are registered in a host computer in advance. The host computer creates an operation instruction schedule for each apparatus on the basis of the pieces of information so as to make the sum of the air pressure consumption amounts of all the apparatuses fall within the air pressure supply ability of the factory equipment and to maximize the productivity. Based on the schedule, the host computer issues operation instructions such as activation, standby operation, and processing. Each semiconductor manufacturing apparatus operates in response to an instruction from the host computer.

(2) Host Computer-Assisted Autonomous Control of Each Apparatus

A semiconductor manufacturing apparatus itself recognizes the current air pressure consumption amount, and notifies the host computer of it. The host computer calculates a suppliable air pressure amount from air pressure consumption amount information from each apparatus and the air pressure supply ability of the factory registered in advance. The host computer notifies each apparatus of the calculated air pressure amount.

Before shifting to the next operation state, the semiconductor manufacturing apparatus checks whether it can shift on the basis of an air pressure consumption amount after the shift and the suppliable air pressure information from the host computer. If the apparatus can shift, it shifts to the next operation state; otherwise, stands by in the current state.

The current air pressure consumption amount information may be acquired not by the semiconductor manufacturing apparatus but directly by the host computer using an air pressure amount measurement device or the like.

(3) Host Computer-Independent Autonomous Control of Each Apparatus

A semiconductor manufacturing apparatus itself recognizes the current air pressure consumption amount, and notifies another semiconductor manufacturing apparatus of it via an on-line equipment. The semiconductor manufacturing apparatus calculates a usable air pressure amount from air pressure consumption amount information from another apparatus and the air pressure supply ability of the factory registered in advance.

Before shifting to the next operation state, the semiconductor manufacturing apparatus checks whether it can shift on the basis of an air pressure consumption amount after the shift and the calculated suppliable air pressure amount information. If the apparatus can shift, it shifts to the next operation state; otherwise, monitors information from another apparatus and stands by in the current state until it can shift.

(First Example)

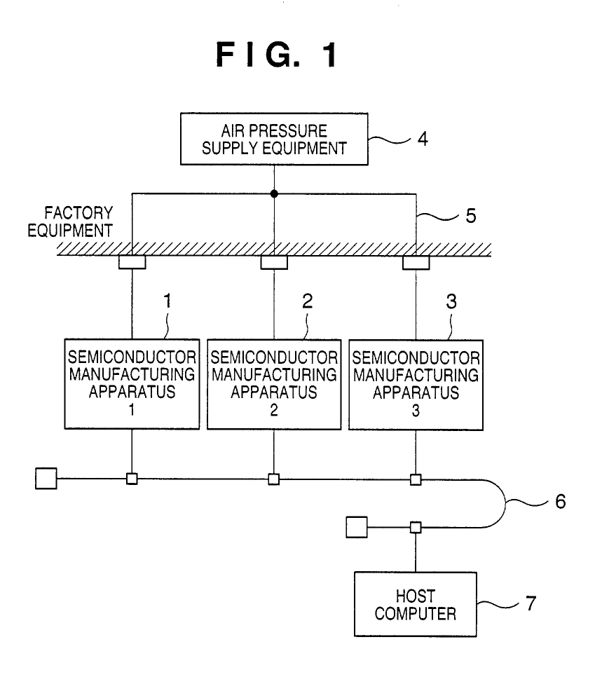

The first example will be described with reference to FIG. 1.

Semiconductor manufacturing apparatuses 1, 2, and 3 installed in a semiconductor manufacturing factory receive air pressures via an air pressure supply line 5 from an air pressure supply equipment 4 serving as a factory equipment. The respective semiconductor manufacturing apparatuses are connected to a host computer 7 via a communication line 6.

The air pressure supply equipment 4 includes a plurality of air pressure supply equipments depending on the pressure level such as a positive or negative pressure, and the type of air pressure such as CA (Clean Air), CDA (Clean Dry Air), or N₂. This example will explain one air pressure supply equipment for descriptive convenience.

The air pressure consumption amount profile will be described.

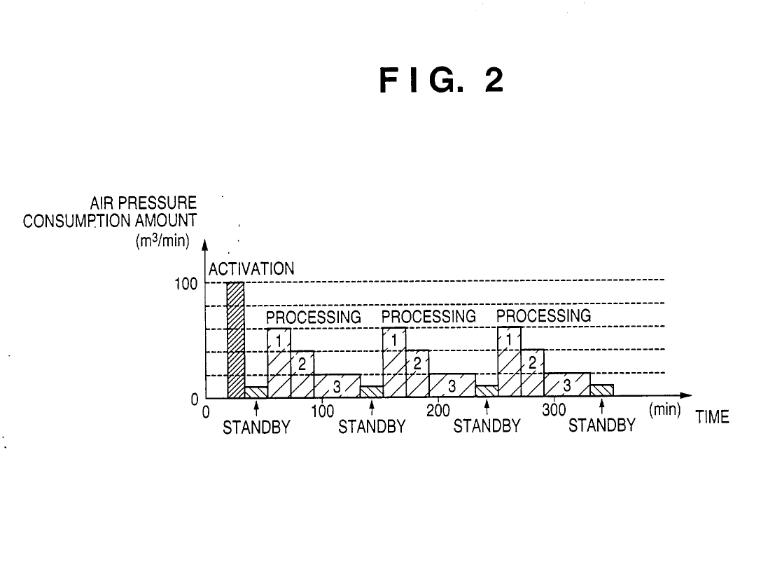

FIG. 2 shows the air pressure consumption amount profile of a given air pressure system for the semiconductor manufacturing apparatus in the first example. The ordinate represents the air pressure consumption amount (by the flow rate), and the abscissa represents the time. Operation contents are activation, standby operation, processing 1, processing 2, and processing 3. Processing 1, processing 2, and processing 3 form a basic processing sequence in an order named. An apparatus can stand by between processes, and all apparatuses stand by while they wait for processing.

According to the profile, activation requires a maximum air pressure consumption amount of 100 m³/min, and the time is 10 min.

Processing 1 requires an air pressure amount of 60 m³/min, and the time is 20 min.

Processing 2 requires an air pressure amount of 40 m³/min, and the time is 20 min.

Processing 3 requires an air pressure amount of 20 m³/min, and the time is 40 min.

The standby state requires an air pressure amount of 10 m³/min, and the time is indefinite.

The air pressure consumption amount actually varies during each processing, but is represented by the maximum value.

The semiconductor manufacturing apparatus creates such an air pressure consumption amount profile by measuring the air pressure consumption amount and time of each operation in advance. The air pressure consumption amount profile of each semiconductor manufacturing apparatus and the supply ability of the air pressure supply equipment are registered in the host computer.

The host computer creates an apparatus control schedule which describes the activation timing of each apparatus and the start timing of each processing on the basis of the air pressure consumption amount profile of each semiconductor manufacturing apparatus and the air pressure supply ability of the equipment so as to maximize the productivity.

The basic concept of creating the apparatus control schedule is as follows.

(1) The activation air pressure is not repetitively generated. Apparatuses are activated with a timing shift by limiting the number of apparatuses to be activated simultaneously such that the air pressure consumption amount in simultaneous activation falls within the supply ability.

(2) A peak model in which the air pressure amount profile in processing is divided into a peak air pressure and the remaining base air pressure is created. The peak time ratio (peak duty) in processing is calculated from the peak model. To minimize peak overlapping, a processing shift time by which the processing timing is shifted for each apparatus is calculated.

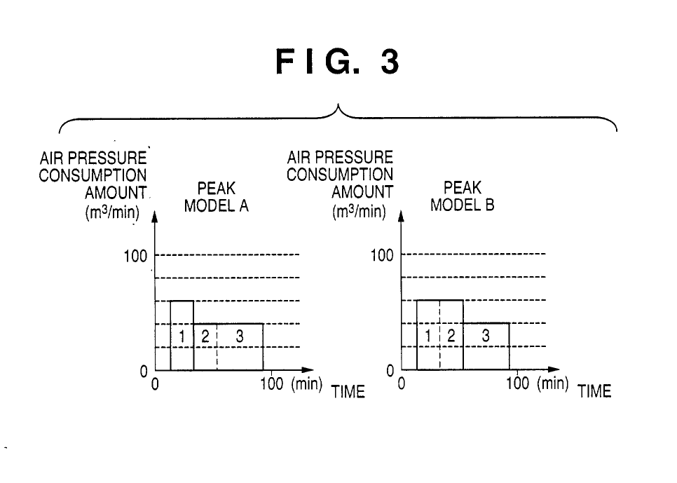

A peak model created from the air pressure consumption amount profile in FIG. 2 is model A or B in FIG. 3. For a sufficiently large number of apparatuses, a model with a smaller difference from the air pressure amount profile is selected. For a small number of apparatuses, it may be more advantageous to select a model with a low peak duty rather than one with a small difference from the air pressure amount profile.

In this case, model A is selected. In this example, the peak duty is 0.25.

The processing shift time is calculated by the processing period (80 min)×the peak duty (0.25), and is 20 min in this example. The shift time is repeated within the processing period.

(3) For the peak air pressure amount=P, the base air pressure amount=B, and the peak duty=D, the air pressure amount=W necessary to operate n apparatuses is given by

W=(P−B)INT(Dn)+Bn . . . (1)

where INT(Dn) is an integer rounded up from the product of D and n.

Assuming that W is a default value, the condition of D is

INT(Dn)<(W−Bn)/(P−B) . . . (2)

As long as the peak duty D satisfies this condition, apparatus control can be achieved as a whole while the productivity of a single apparatus is maintained. Also, the air pressure supply equipment can be reduced. In this case, a necessary equipment supply air pressure amount is given by equation (1).

If D does not satisfy the condition, the supply air pressure amount W must be increased to maintain the productivity of a single apparatus by the entire factory. When the supply air pressure amount cannot be increased, the standby time is inserted to realize optimal productivity with the current supply air pressure amount.

Apparatus control schedules for the three semiconductor manufacturing apparatuses 1, 2, and 3 are created using the air pressure consumption amount profile of FIG. 2 along the apparatus control schedule creation concept described above.

In the use of peak model A in FIG. 3, the parameters are

P=60 (m³/min)

B=40 (m³/min)

D=0.25

W is calculated using equation (1):

W=140 (m³/min)

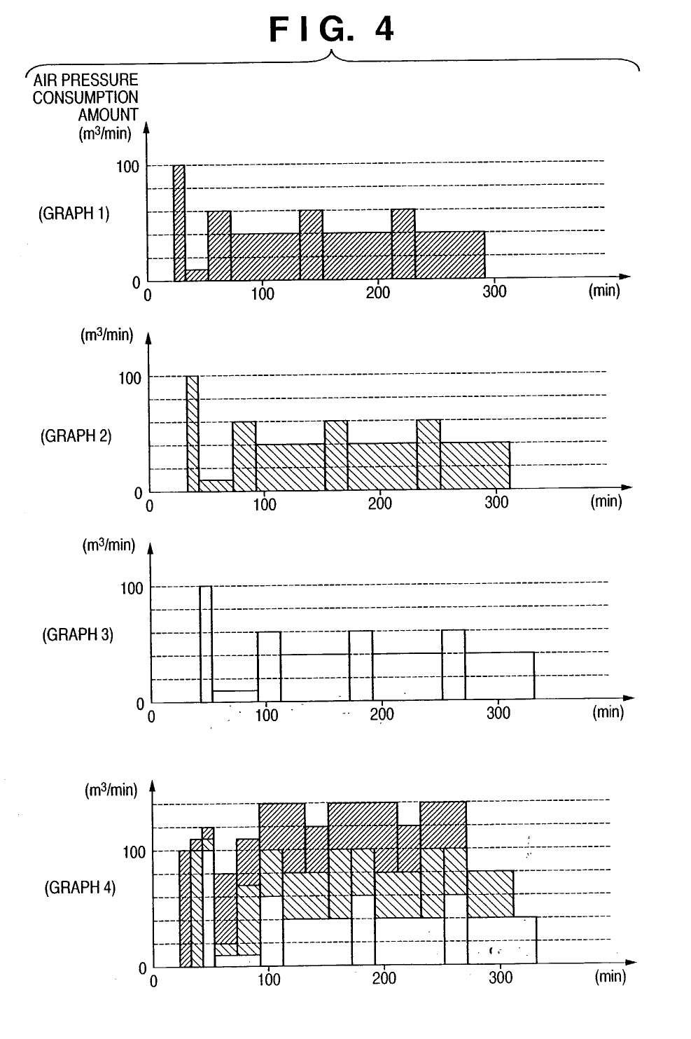

The processing shift time is 20 min, and apparatus control schedules using the peak model are those shown in FIG. 4. Graphs 1, 2, and 3 represent the apparatus control schedules of the semiconductor manufacturing apparatuses 1, 2, and 3, and graph 4 represents the total air pressure consumption amount of the three apparatuses. From calculation, the total air pressure consumption amount falls within 140 (m³/min).

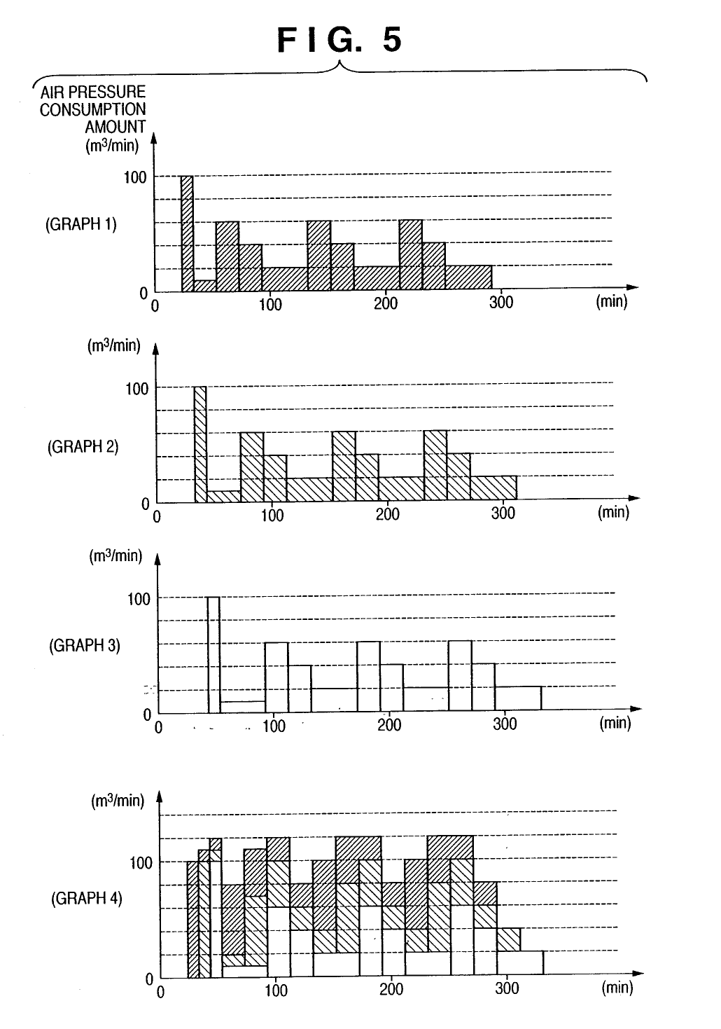

FIG. 5 shows actual apparatus control schedules created using the air pressure consumption amount profile. Similar to FIG. 4, graphs 1, 2, and 3 represent the apparatus control schedules of the semiconductor manufacturing apparatuses 1, 2, and 3, and graph 4 represents the total air pressure consumption amount. As is apparent from FIG. 5, the actual total air pressure consumption amount is merely 120 (m³/min), which is different from 140 (m³/min) due to an error between the profile and the peak model.

When the air pressure supply ability of the equipment registered in the host computer in advance is 120 (m³/min) or less, the host computer generates a warning about an insufficient air pressure supply ability. Alternatively, the host computer inserts a proper standby time so as to satisfy a peak duty calculated by inequality (2), and creates an apparatus control schedule complying with the air pressure supply ability. This selection is set in the host computer in advance.

The host computer issues instructions to the semiconductor manufacturing apparatuses 1, 2, and 3 via the communication line 6 in accordance with the created apparatus control schedules. The semiconductor manufacturing apparatuses 1, 2, and 3 perform control in accordance with the instructions.

In the first example, the air pressure supply ability of the equipment suffices to be 120 (m³/min) or more in order to operate the three apparatuses while maintaining the productivity of a single apparatus. An optimal air pressure supply equipment can also be determined from air pressure consumption amount profile information of the apparatus.

The conventional system requires an air pressure supply ability of 300 (m³/min) for covering the activation air pressure amounts of all apparatuses, and 180 (m³/min) for covering the peak air pressure amount in processing. Compared to this, the air pressure supply equipment of the first example suffices to have 40% and 67% air pressure supply abilities in activation and processing. This difference is very significant when the number of apparatuses increases to several hundred. In addition, it can be avoided that activation air pressure amounts accidentally coincide with each other and supply of the air pressure runs short.

Even if the air pressure supply ability is 120 (m³/min) or less, optimal productivity complying with the air pressure supply ability can be realized by creating an apparatus control schedule in which a proper standby time is inserted.

(Second Example)

The second example will be described with reference to FIG. 1.

The arrangement is the same as that of the first example.

Semiconductor manufacturing apparatuses 1, 2, and 3 installed in a semiconductor manufacturing factory receive air pressures via an air pressure supply line 5 from an air pressure supply equipment 4 serving as a factory equipment. The respective semiconductor manufacturing apparatuses are connected to a host computer 7 via a communication line 6.

The semiconductor manufacturing apparatuses 1, 2, and 3 measure their air pressure consumption amount profiles in advance, and register the profiles in them. The semiconductor manufacturing apparatuses 1, 2, and 3 read out current air pressure consumption amounts from the air pressure consumption amount profiles in accordance with the current processing states, and notify the host computer 7 via the communication line 6 of the current air pressure consumption amounts.

The host computer 7 always monitors the air pressure consumption amounts from the semiconductor manufacturing apparatuses 1, 2, and 3, and calculates the total air pressure consumption amount. At the same time, the host computer 7 calculates a currently usable air pressure amount from the air pressure supply ability of the equipment registered in advance, and notifies the semiconductor manufacturing apparatuses 1, 2, and 3 via the communication line 6 of the usable air pressure amount.

Before shifting to the next processing state, the semiconductor manufacturing apparatuses 1, 2, and 3 read out air pressure consumption amounts in the next processing state from the air pressure consumption amount profiles, and calculate differences from the current air pressure consumption amounts. If the differences represent that the air pressure consumption amount will decrease, the semiconductor manufacturing apparatuses 1, 2, and 3 shift to the next processing state, and notify the host computer 7 of new air pressure consumption amounts.

If the differences represent that the air pressure consumption amount will increase, the semiconductor manufacturing apparatuses 1, 2, and 3 check whether the currently usable air pressure amount notified by the host computer is larger than the differences. If the currently usable air pressure amount is larger, the semiconductor manufacturing apparatuses 1, 2, and 3 shift to the next processing state, and notify the host computer 7 of new air pressure consumption amounts.

If the usable air pressure amount is smaller than the differences, the semiconductor manufacturing apparatuses 1, 2, and 3 stop the shift because supply of the air pressure from the air pressure supply equipment 4 runs short if they shift to the next state. The semiconductor manufacturing apparatuses 1, 2, and 3 stand by until they can shift on the basis of usable air pressure amount information notified by the host computer 7. The semiconductor manufacturing apparatuses 1, 2, and 3 notify the host computer 7 of standby air pressure amounts. If the operation state of another apparatus changes and it is determined from usable air pressure amount information notified by the host computer 7 that the semiconductor manufacturing apparatuses 1, 2, and 3 can shift, they shift to the next processing state and notify the host computer 7 of new air pressure consumption amounts.

In this fashion, optimal productivity complying with the air pressure supply ability of the air pressure supply equipment 4 can be realized by autonomous decision of each semiconductor manufacturing apparatus.

To recognize the current air pressure consumption amount, the semiconductor manufacturing apparatuses 1, 2, and 3 may read measurement values from attached air pressure consumption amount measurement devices, instead of air pressure consumption amount profile information.

Alternatively, the host computer 7 may read measurement values from air pressure consumption amount measurement devices attached to the semiconductor manufacturing apparatuses 1, 2, and 3.

(Third Example)

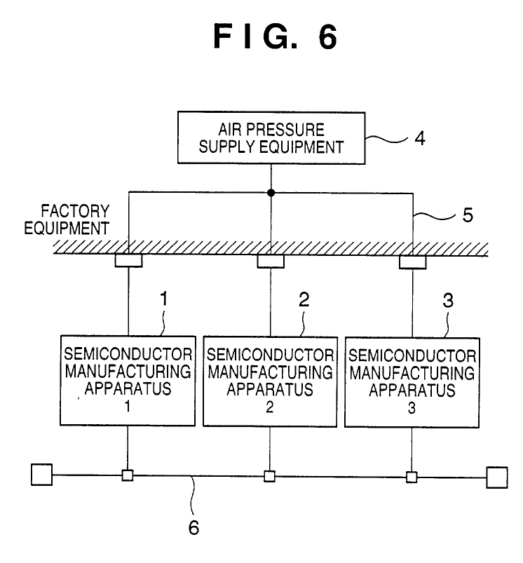

The third example will be described with reference to FIG. 6.

Semiconductor manufacturing apparatuses 1, 2, and 3 installed in a semiconductor manufacturing factory receive air pressures via an air pressure supply line 5 from an air pressure supply equipment 4 serving as a factory equipment. The semiconductor manufacturing apparatuses 1, 2, and 3 are connected via a communication line 6.

The semiconductor manufacturing apparatuses 1, 2, and 3 read out current air pressure consumption amounts from their air pressure consumption amount profiles in accordance with the current processing states, and notify the remaining semiconductor manufacturing apparatuses via the communication line of the current air pressure consumption amounts.

The semiconductor manufacturing apparatuses 1, 2, and 3 monitor air pressure consumption amounts from the remaining apparatuses, and calculate the total air pressure consumption amount. At the same time, the semiconductor manufacturing apparatuses 1, 2, and 3 calculate a currently usable air pressure amount from the air pressure supply ability of the equipment registered in advance and the total air pressure consumption amount.

Before shifting to the next processing state, the semiconductor manufacturing apparatuses 1, 2, and 3 read out air pressure consumption amounts in the next processing state from the air pressure consumption amount profiles, and calculate differences from the current air pressure consumption amounts. If the differences represent that the air pressure consumption amount will decrease, the semiconductor manufacturing apparatuses 1, 2, and 3 shift to the next processing state, and notify the remaining semiconductor manufacturing apparatuses of new air pressure consumption amounts.

If the differences represent that the air pressure consumption amount will increase, the semiconductor manufacturing apparatuses 1, 2, and 3 check whether the currently usable air pressure amount calculated is larger than the differences. If the currently usable air pressure amount is larger, the semiconductor manufacturing apparatuses 1, 2, and 3 shift to the next processing state, and notify the remaining semiconductor manufacturing apparatuses of new air pressure consumption amounts.

If the usable air pressure amount is smaller than the differences, the semiconductor manufacturing apparatuses 1, 2, and 3 stop the shift because supply of the air pressure from the air pressure supply equipment 4 runs short if they shift to the next state. The semiconductor manufacturing apparatuses 1, 2, and 3 notify the remaining semiconductor manufacturing apparatuses of standby air pressure amounts. The semiconductor manufacturing apparatuses 1, 2, and 3 check whether they can shift, from air pressure consumption amount information sequentially reported by the remaining apparatuses, and stand by until they can shift. If an air pressure consumption amount notified by another apparatus changes and it is determined that the semiconductor manufacturing apparatuses 1, 2, and 3 can shift, they shift to the next processing state and notify the remaining semiconductor manufacturing apparatuses of new air pressure amounts.

Hence, optimal productivity complying with the air pressure supply ability of the air pressure supply equipment 4 can be realized by autonomous decision of each semiconductor manufacturing apparatus.

(Second Embodiment)

The outline of the second embodiment will be explained.

In most large-scale semiconductor manufacturing factories which house many semiconductor manufacturing apparatuses, a so-called on-line equipment which connects a host computer and many semiconductor manufacturing apparatuses via a communication means such as a LAN is installed to perform centralized information management of the semiconductor manufacturing apparatuses.

The second embodiment is characterized by the following methods using the on-line equipment.

(1) Centralized Control by Host Computer

The power consumption profiles of respective apparatuses and the power supply ability of a factory equipment are registered in a host computer in advance. The host computer creates an operation instruction schedule for each apparatus on the basis of the pieces of information so as to make the sum of the power consumptions of all the apparatuses fall within the power supply ability of the factory equipment and to maximize the productivity. Based on the schedule, the host computer issues operation instructions such as activation, standby operation, and processing. Each semiconductor manufacturing apparatus operates in response to an instruction from the host computer.

(2) Host Computer-Assisted Autonomous Control of Each Apparatus

A semiconductor manufacturing apparatus itself recognizes the current power consumption, and notifies the host computer of it. The host computer calculates a suppliable power from power consumption information from each apparatus and the power supply ability of the factory registered in advance. The host computer notifies each apparatus of the calculated power.

Before shifting to the next operation state, the semiconductor manufacturing apparatus checks whether it can shift on the basis of power consumption after the shift and the suppliable power information from the host computer. If the apparatus can shift, it shifts to the next operation state; otherwise, stands by in the current state.

The current power consumption information may be acquired not by the semiconductor manufacturing apparatus but directly by the host computer using a power measurement device or the like.

(3) Host Computer-Independent Autonomous Control of Each Apparatus

A semiconductor manufacturing apparatus itself recognizes the current power consumption, and notifies another semiconductor manufacturing apparatus of it via an on-line equipment. The semiconductor manufacturing apparatus calculates a usable power from power consumption information from another apparatus and the power supply ability of the factory registered in advance.

Before shifting to the next operation state, the semiconductor manufacturing apparatus checks whether it can shift on the basis of a power consumption after the shift and the calculated suppliable power information. If the apparatus can shift, it shifts to the next operation state; otherwise, monitors information from another apparatus and stands by in the current state until it can shift.

(First Example)

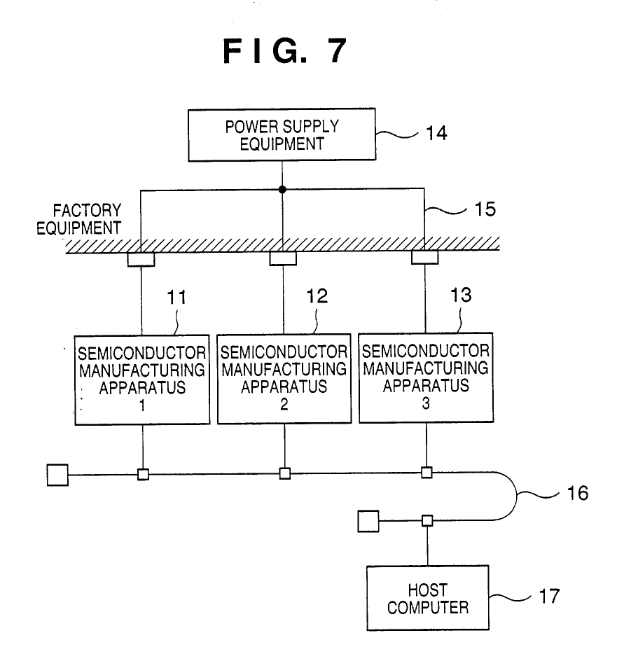

The first example will be described with reference to FIG. 7.

Semiconductor manufacturing apparatuses 11, 12, and 13 installed in a semiconductor manufacturing factory receive power via a power supply line 15 from a power supply equipment 14 serving as a factory equipment. The respective semiconductor manufacturing apparatuses are connected to a host computer 17 via a communication line 16.

The power consumption profile will be described.

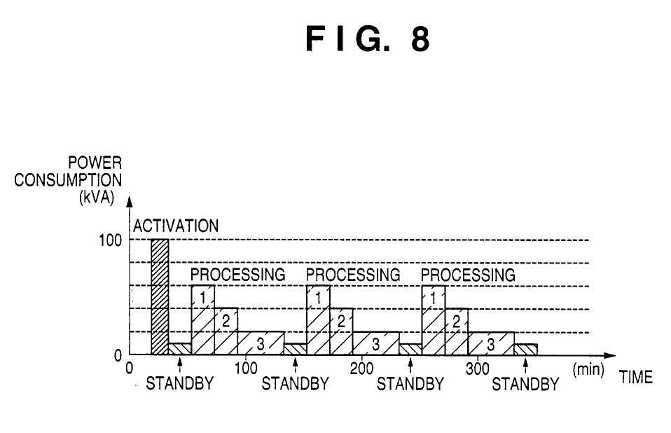

FIG. 8 shows the power consumption profile of the semiconductor manufacturing apparatus in the first example. The ordinate represents the power consumption, and the abscissa represents the time. Operation contents are activation, standby operation, processing 1, processing 2, and processing 3. Processing 1, processing 2, and processing 3 form a basic processing sequence in an order named. An apparatus can stand by between processes, and all apparatuses stand by while they wait for processing.

According to the profile, activation requires a maximum power consumption of 100 kVA, and the time is 10 min.

Processing 1 requires a power of 60 kVA, and the time is 20 min.

Processing 2 requires a power of 40 kVA, and the time is 20 min.

Processing 3 requires a power of 20 kVA, and the time is 40 min.

The standby state requires a power of 10 kVA, and the time is indefinite.

The power consumption actually varies during each processing, but is represented by the maximum value.

The semiconductor manufacturing apparatus creates such a power consumption profile by measuring the power consumption and time of each operation content in advance. The power consumption profile of each semiconductor manufacturing apparatus and the power supply ability of the power supply equipment are registered in the host computer.

The host computer creates an apparatus control schedule which describes the activation timing of each apparatus and the start timing of each processing on the basis of the power consumption profile of each semiconductor manufacturing apparatus and the power supply ability of the equipment so as to maximize the productivity.

The basic concept of creating the apparatus control schedule is as follows.

(1) The activation power is not repetitively generated. Apparatuses are activated with a timing shift by limiting the number of apparatuses to be activated simultaneously such that the power consumption in simultaneous activation falls within the supply ability.

(2) A peak model in which the power profile in processing is divided into a peak power and the remaining base power is created. The peak time ratio (peak duty) in processing is calculated from the peak model. To minimize peak overlapping, a processing shift time by which the processing timing is shifted for each apparatus is calculated.

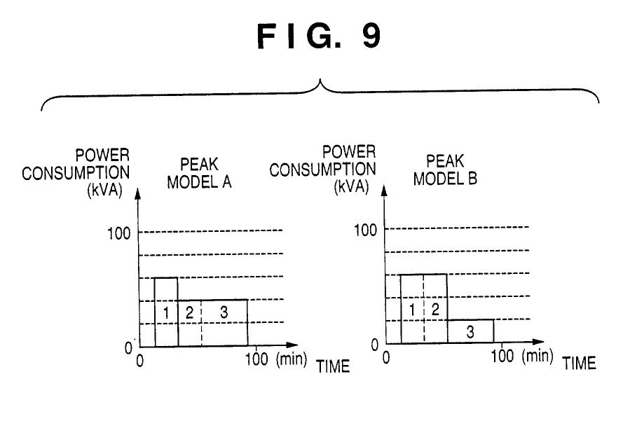

A peak model created from the power consumption profile in FIG. 8 is model A or B in FIG. 9. For a sufficiently large number of apparatuses, a model with a smaller difference from the power profile is selected. For a small number of apparatuses, it may be more advantageous to select a model with a low peak duty rather than one with a small difference from the power profile.

In this case, model A is selected. In this example, the peak duty is 0.25.

The processing shift time is calculated by the processing period (80 min)×the peak duty (0.25), and is 20 min in this example. The shift time is repeated within the processing period.

(3) For the peak power=P, the base power=B, and the peak duty=D, the power=W necessary to operate n apparatuses is given by

W=(P−B)INT(Dn)+Bn . . . (3)

where INT(Dn) is an integer rounded up from the product of D and n.

Assuming that W is a default value, the condition of D is

INT(Dn)<(W−Bn)/(P−B) . . . (4)

As long as the peak duty D satisfies this condition, apparatus control can be achieved as a whole while the productivity of a single apparatus is maintained. Also, the power supply equipment can be reduced. In this case, necessary equipment supply power is given by equation (3).

If D does not satisfy the condition, the supply power W must be increased to maintain the productivity of a single apparatus by the entire factory. When the supply power cannot be increased, the standby time is inserted to realize optimal productivity with the current supply power.

Apparatus control schedules for the three semiconductor manufacturing apparatuses 11, 12, and 13 are created using the power consumption profile of FIG. 8 along the apparatus control schedule creation concept described above.

In the use of peak model A in FIG. 9, the parameters are

P=60 (kVA)

B=40 (kVA)

D=0.25

W is calculated using equation (3):

W=140 (kVA)

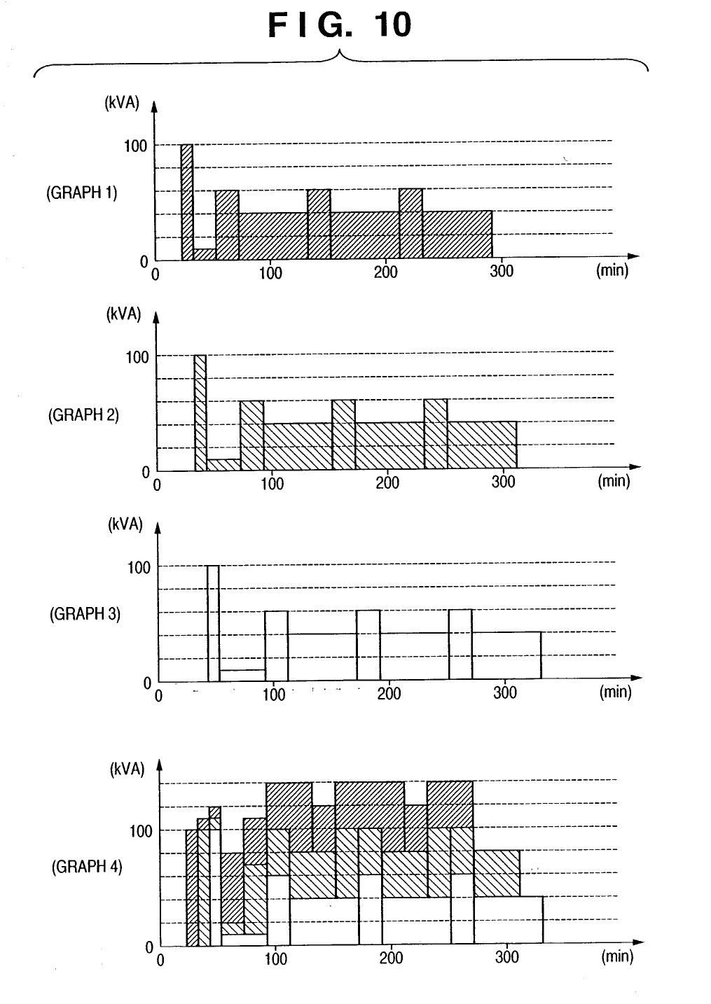

The processing shift time is 20 min, and apparatus control schedules using the peak model are those as shown in FIG. 10. Graphs 1, 2, and 3 represent the apparatus control schedules of the semiconductor manufacturing apparatuses 11, 12, and 13, and graph 4 represents the total power consumption of the three apparatuses. From calculation, the total power consumption falls within 140 (kVA).

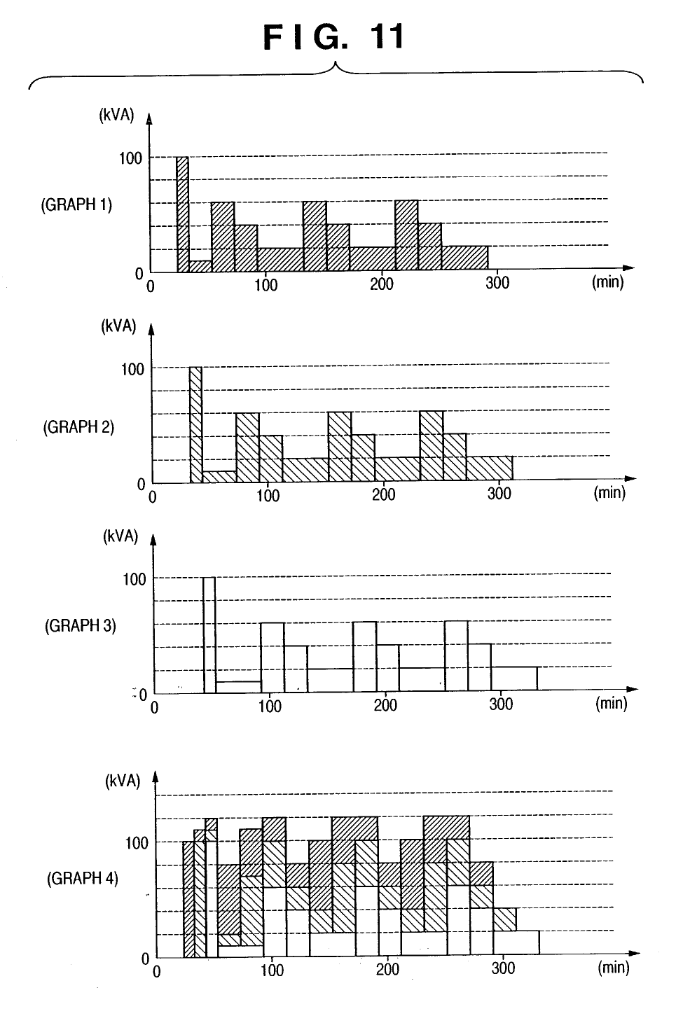

FIG. 11 shows actual apparatus control schedules created using the power consumption profile. Similar to FIG. 10, graphs 1, 2, and 3 represent the apparatus control schedules of the semiconductor manufacturing apparatuses 11, 12, and 13, and graph 4 represents the total power consumption. As is apparent from FIG. 11, the actual total power consumption is merely 120 (kVA), which is different from 140 (kVA) due to an error between the profile and the peak model.

When the power supply ability of the equipment registered in the host computer in advance is 120 (kVA) or less, the host computer generates a warning about an insufficient power supply ability. Alternatively, the host computer inserts a proper standby time so as to satisfy a peak duty calculated by inequality (4), and creates an apparatus control schedule complying with the power supply ability. This selection is set in the host computer in advance.

The host computer issues instructions to the semiconductor manufacturing apparatuses 11, 12, and 13 via the communication line 16 in accordance with the created apparatus control schedules. The semiconductor manufacturing apparatuses 11, 12, and 13 perform control in accordance with the instructions.

In the first example, the power supply ability of the equipment suffices to be 120 (kVA) or more in order to operate the three apparatuses while maintaining the productivity of a single apparatus. An optimal power supply equipment can also be determined from power consumption profile information of the apparatus.

The conventional system requires a power supply ability of 300 (kVA) for covering the activation powers of all apparatuses, and 180 (kVA) for covering the peak power in processing. Compared to this, the power supply equipment of the first example suffices to have 40% and 67% power supply abilities in activation and processing. This difference is very significant when the number of apparatuses increases to several hundred. In addition, it can be avoided that activation powers accidentally coincide with each other and supply of power runs short.

Even if the power supply ability is 120 (kVA) or less, optimal productivity complying with the power supply ability can be realized by creating an apparatus control schedule in which a proper standby time is inserted.

(Second Example)

The second example will be described with reference to FIG. 7.

The arrangement is the same as that of the first example.

Semiconductor manufacturing apparatuses 11, 12, and 13 installed in a semiconductor manufacturing factory receive power via a power supply line 15 from a power supply equipment 14 serving as a factory equipment. The respective semiconductor manufacturing apparatuses are connected to a host computer 17 via a communication line 16.

The semiconductor manufacturing apparatuses 11, 12, and 13 register their power consumption profiles. The semiconductor manufacturing apparatuses 11, 12, and 13 read out current power consumptions from the power consumption profiles in accordance with the current processing states, and notify the host computer 17 via the communication line 16 of the current power consumptions.

The host computer 17 always monitors the power consumption amounts from the semiconductor manufacturing apparatuses 11, 12, and 13, and calculates the total power consumption. At the same time, the host computer 17 calculates a currently usable power from the power supply ability of the equipment registered in advance, and notifies the semiconductor manufacturing apparatuses 11, 12, and 13 via the communication line 16 of the usable power.

Before shifting to the next processing state, the semiconductor manufacturing apparatuses 11, 12, and 13 read out power consumptions in the next processing state from the power consumption profiles, and calculate differences from the current power consumptions. If the differences represent that the power consumption will decrease, the semiconductor manufacturing apparatuses 11, 12, and 13 shift to the next processing state, and notify the host computer 17 of new power consumptions.

If the differences represent that the power consumption will increase, the semiconductor manufacturing apparatuses 11, 12, and 13 check whether the currently usable power notified by the host computer is larger than the differences. If the currently usable power is larger, the semiconductor manufacturing apparatuses 11, 12, and 13 shift to the next processing state, and notify the host computer 17 of new power consumptions.

If the usable power is smaller than the difference, the semiconductor manufacturing apparatuses 11, 12, and 13 stop the shift because supply of power from the power supply equipment 14 runs short if they shift to the next state. The semiconductor manufacturing apparatuses 11, 12, and 13 stand by until they can shift on the basis of usable power information notified by the host computer 17. The semiconductor manufacturing apparatuses 11, 12, and 13 notify the host computer 17 of standby powers. If the operation state of another apparatus changes and it is determined from usable power information notified by the host computer 17 that the semiconductor manufacturing apparatuses 11, 12, and 13 can shift, they shift to the next processing state and notify the host computer 17 of new power consumptions.

As a result, optimal productivity complying with the power supply ability of the power supply equipment 14 can be realized by autonomous decision of each semiconductor manufacturing apparatus.

To recognize the current power consumption, the semiconductor manufacturing apparatuses 11, 12, and 13 may read measurement values from attached power consumption measurement devices, instead of power consumption profile information.

Alternatively, the host computer 17 may read measurement values from power consumption measurement devices attached to the semiconductor manufacturing apparatuses 11, 12, and 13.

(Third Example)

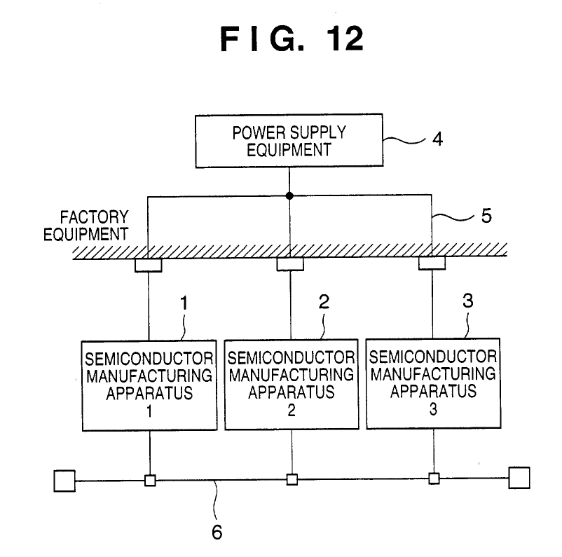

The third example will be described with reference to FIG. 12.

Semiconductor manufacturing apparatuses 11, 12, and 13 installed in a semiconductor manufacturing factory receive power via a power supply line 15 from a power supply equipment 14 serving as a factory equipment. The semiconductor manufacturing apparatuses 11, 12, and 13 are connected via a communication line 16.

The semiconductor manufacturing apparatuses 11, 12, and 13 read out current power consumptions from their power consumption profiles in accordance with the current processing states, and notify the remaining semiconductor manufacturing apparatuses via the communication line of the current power consumptions.

The semiconductor manufacturing apparatuses 11, 12, and 13 monitor power consumptions from the remaining apparatuses, and calculate the total power consumption. At the same time, the semiconductor manufacturing apparatuses 11, 12, and 13 calculate a currently usable power from the power supply ability of the equipment registered in advance and the total power consumption.

Before shifting to the next processing state, the semiconductor manufacturing apparatuses 11, 12, and 13 read out power consumptions in the next processing state from the power consumption profiles, and calculate differences from the current power consumptions. If the differences represent that the power consumption will decrease, the semiconductor manufacturing apparatuses 11, 12, and 13 shift to the next processing state, and notify the remaining semiconductor manufacturing apparatuses of new power consumptions.

If the differences represent that the power consumption will increase, the semiconductor manufacturing apparatuses 11, 12, and 13 check whether the currently usable power calculated is larger than the differences. If the currently usable power is larger, the semiconductor manufacturing apparatuses 11, 12, and 13 shift to the next processing state, and notify the remaining semiconductor manufacturing apparatuses of new power consumptions.

If the usable power is smaller than the differences, the semiconductor manufacturing apparatuses 11, 12, and 13 stop the shift because supply of power from the power supply equipment 14 runs short if they shift to the next state. The semiconductor manufacturing apparatuses 11, 12, and 13 notify the remaining semiconductor manufacturing apparatuses of standby powers. The semiconductor manufacturing apparatuses 11, 12, and 13 check whether they can shift on the basis of power consumption information sequentially reported by the remaining apparatuses, and stand by until they can shift. If a power consumption amount notified by another apparatus changes and it is determined that the semiconductor manufacturing apparatuses 11, 12, and 13 can shift, they shift to the next processing state and notify the remaining semiconductor manufacturing apparatuses of new powers.

Optimal productivity complying with the power supply ability of the power supply equipment 14 can be realized by autonomous decision of each semiconductor manufacturing apparatus.

[Other Embodiment]

The object of each embodiment is also achieved when a storage medium (or recording medium) which stores software program codes for realizing the functions of the above-described embodiments is supplied to a system or apparatus, and the computer (or the CPU or MPU) of the system or apparatus reads out and executes the program codes stored in the storage medium. In this case, the program codes read out from the storage medium realize the functions of the above-described embodiments, and the storage medium which stores the program codes constitutes the present invention. The functions of the above-described embodiments are realized when the computer executes the readout program codes. Also, the functions of the above-described embodiments are realized when an OS (Operating System) running on the computer performs part or all of actual processing on the basis of the instructions of the program codes.

The functions of the above-described embodiments are also realized when the program codes read out from the storage medium are written in the memory of a function expansion card inserted into the computer or the memory of a function expansion unit connected to the computer, and the CPU of the function expansion card or function expansion unit performs part or all of actual processing on the basis of the instructions of the program codes.

As has been described above, according to the above-described embodiments, the capacity of the air pressure supply equipment of a semiconductor manufacturing factory can be reduced in comparison with the conventional system. The present invention can contribute to cost reduction and energy saving of the factory equipment while maintaining optimal productivity.

The present invention can realize optimal productivity complying with the air pressure supply ability in a factory with a low-ability air pressure supply equipment.

The capacity of the power supply equipment of the semiconductor manufacturing factory can be reduced in comparison with the conventional system. The present invention can contribute to cost reduction and energy saving of the factory equipment while maintaining optimal productivity.

The present invention can realize optimal productivity complying with the power supply ability in a factory with a low-ability power supply equipment.

The present invention is not limited to the above embodiments and various changes and modifications can be made within the spirit and scope of the present invention. Therefore, to apprise the public of the scope of the present invention the following claims are made.

What is claimed is:

1. A manufacturing system comprising:
a plurality of processing apparatuses;
an air pressure supply apparatus which supplies a gas pressure to said plurality of processing apparatuses; and
a control apparatus for controlling said plurality of processing apparatuses,
wherein said control apparatus creates operation schedules for said plurality of processing apparatuses on the basis of temporal change information of an air pressure consumption amount corresponding to an operation order of each of said plurality of processing apparatuses so as to prevent a sum of air pressure consumption amounts of said plurality of processing apparatuses from exceeding an air pressure supply ability of said air pressure supply apparatus.

2. The system according to claim 1, wherein said each processing apparatus includes a semiconductor manufacturing apparatus.

3. A control apparatus for controlling a manufacturing system having a plurality of processing apparatuses, and an air pressure supply apparatus which supplies a gas pressure to the plurality of processing apparatuses, wherein
the control apparatus creates operation schedules for the plurality of processing apparatuses on the basis of temporal change information of an air pressure consumption amount corresponding to an operation order of each of the plurality of processing apparatuses so as to prevent a sum of air pressure consumption amounts of the plurality of processing apparatuses from exceeding an air pressure supply ability of the air pressure supply apparatus.

4. The apparatus according to claim 3, wherein said each processing apparatus includes a semiconductor manufacturing apparatus.

5. A control method of controlling a manufacturing system having a plurality of processing apparatuses, and an air pressure supply apparatus which supplies a gas pressure to the plurality of processing apparatuses, comprising:
creating operation schedules for the plurality of processing apparatuses on the basis of temporal change information of an air pressure consumption amount corresponding to an operation order of each of the plurality of processing apparatuses so as to prevent a sum of air pressure consumption amounts of the plurality of processing apparatuses from exceeding an air pressure supply ability of the air pressure supply apparatus; and
operating the plurality of processing apparatuses on the basis of the created operation schedules.

6. The method according to claim 5, wherein said each processing apparatus includes a semiconductor manufacturing apparatus.

7. A control program wherein the control program causes a computer to execute the control method defined in claim 5.

8. A storage medium wherein the storage medium computer-readably stores the control program defined in claim 7.

9. A manufacturing system comprising:
a plurality of processing apparatuses;
an air pressure supply apparatus which supplies a gas pressure to said plurality of processing apparatuses;
a control apparatus for controlling said plurality of processing apparatuses; and
detection means for detecting an air pressure consumption amount of each of said plurality of processing apparatuses,
wherein said control apparatus calculates a usable air pressure amount on the basis of air pressure consumption amount information of said processing apparatus detected by said detection means and air pressure supply ability information of said air pressure supply apparatus, and notifies said processing apparatus of the usable air pressure amount.

10. The system according to claim 9, wherein said control apparatus controls said each processing apparatus on the basis of temporal change information of an air pressure consumption amount corresponding to an operation order of said each processing apparatus so as to prevent a sum of air pressure consumption amounts of said plurality of processing apparatuses from exceeding an air pressure supply ability of said air pressure supply apparatus.

11. The system according to claim 9, wherein said each processing apparatus includes a semiconductor manufacturing apparatus.

12. A control apparatus for controlling a manufacturing system having a plurality of processing apparatuses, and an air pressure supply apparatus which supplies a gas pressure to the plurality of processing apparatuses, wherein
the control apparatus detects an air pressure consumption amount of each of the plurality of processing apparatuses, calculates a usable air pressure amount on the basis of detected air pressure consumption amount information of the processing apparatus and air pressure supply ability information of the air pressure supply apparatus, and notifies the processing apparatus of the usable air pressure amount.

13. The apparatus according to claim 12, wherein the control apparatus controls said each processing apparatus on the basis of temporal change information of an air pressure consumption amount corresponding to an operation order of said each processing apparatus so as to prevent a sum of air pressure consumption amounts of the plurality of processing apparatuses from exceeding an air pressure supply ability of the air pressure supply apparatus.

14. The apparatus according to claim 12, wherein said each processing apparatus includes a semiconductor manufacturing apparatus.

15. A control method of controlling a manufacturing system having a plurality of processing apparatuses, and an air pressure supply apparatus which supplies a gas pressure to the plurality of processing apparatuses, comprising:
detecting an air pressure consumption amount of each of the plurality of processing apparatuses;
calculating a usable air pressure amount on the basis of detected air pressure consumption amount information of the processing apparatus and air pressure supply ability information of the air pressure supply apparatus; and
notifying the processing apparatus of the usable air pressure amount.

16. The method according to claim 15, wherein said each processing apparatus is controlled on the basis of temporal change information of an air pressure consumption amount corresponding to an operation order of said each processing apparatus so as to prevent a sum of air pressure consumption amounts of the plurality of processing apparatuses from exceeding an air pressure supply ability of the air pressure supply apparatus.

17. The method according to claim 15, wherein said each processing apparatus includes a semiconductor manufacturing apparatus.

18. A control program wherein the control program causes a computer to execute the control method defined in claim 15.

19. A storage medium wherein the storage medium computer-readably stores the control program defined in claim 18.

20. A manufacturing system comprising:
a plurality of processing apparatuses;
an air pressure supply apparatus which supplies a gas pressure to said plurality of processing apparatuses; and
communication means for allowing communication between said plurality of processing apparatuses,
wherein each of said plurality of processing apparatuses comprises detection means for detecting an air pressure consumption amount of said processing apparatus, notification means for notifying the remaining processing apparatuses via said communication means of the detected air pressure consumption amount, and control means for controlling operation of said processing apparatus on the basis of pieces of air pressure consumption amount information from the remaining processing apparatuses and air pressure supply ability information of said air pressure supply apparatus so as to prevent a sum of air pressure consumption amounts of said plurality of processing apparatuses from exceeding an air pressure supply ability of said air pressure supply apparatus.

21. The system according to claim 20, wherein said each processing apparatus includes a semiconductor manufacturing apparatus.

22. A control method of controlling a manufacturing system having a plurality of processing apparatuses, an air pressure supply apparatus which supplies a gas pressure to the plurality of processing apparatuses, and communication means for allowing communication between the plurality of processing apparatuses, comprising:
causing each of the plurality of processing apparatuses to detect an air pressure consumption amount of the processing apparatus, to notify the remaining processing apparatuses via the communication means of the detected air pressure consumption amount, and to control operation of the processing apparatus on the basis of pieces of air pressure consumption amount information from the remaining processing apparatuses and air pressure supply ability information of the air pressure supply apparatus so as to prevent a sum of air pressure consumption amounts of the plurality of processing apparatuses from exceeding an air pressure supply ability of the air pressure supply apparatus.

23. The method according to claim 22, wherein said each processing apparatus includes a semiconductor manufacturing apparatus.

24. A control program wherein the control program causes a computer to execute the control method defined in claim 22.

25. A storage medium wherein the storage medium computer-readably stores the control program defined in claim 24.

26. A manufacturing system comprising:
a plurality of processing apparatuses;
a power supply apparatus which supplies power to said plurality of processing apparatuses; and
a control apparatus for controlling said plurality of processing apparatuses,
wherein said control apparatus creates operation schedules for said plurality of processing apparatuses on the basis of temporal change information of a power consumption corresponding to an operation order of each of said plurality of processing apparatuses so as to prevent a sum of power consumptions of said plurality of processing apparatuses from exceeding a power supply ability of said power supply apparatus.

27. The system according to claim 26, wherein said each processing apparatus includes a semiconductor manufacturing apparatus.

28. A control apparatus for controlling a manufacturing system having a plurality of processing apparatuses, and a power supply apparatus which supplies power to the plurality of processing apparatuses, wherein
the control apparatus creates operation schedules for the plurality of processing apparatuses on the basis of temporal change information of a power consumption corresponding to an operation order of each of the plurality of processing apparatuses so as to prevent a sum of power consumptions of the plurality of processing apparatuses from exceeding a power supply ability of the power supply apparatus.

29. The apparatus according to claim 28, wherein said each processing apparatus includes a semiconductor manufacturing apparatus.

30. A control method of controlling a manufacturing system having a plurality of processing apparatuses, and a power supply apparatus which supplies power to the plurality of processing apparatuses, comprising:
creating operation schedules for the plurality of processing apparatuses on the basis of temporal change information of a power consumption corresponding to an operation order of each of the plurality of processing apparatuses so as to prevent a sum of power consumptions of the plurality of processing apparatuses from exceeding a power supply ability of the power supply apparatus; and
operating the plurality of processing apparatuses on the basis of the created operation schedules.

31. The method according to claim 30, wherein said each processing apparatus includes a semiconductor manufacturing apparatus.

32. A control program wherein the control program causes a computer to execute the control method defined in claim 30.

33. A storage medium wherein the storage medium computer-readably stores the control program defined in claim 32.

34. A manufacturing system comprising:
a plurality of processing apparatuses;
a power supply apparatus which supplies power to said plurality of processing apparatuses;
a control apparatus for controlling said plurality of processing apparatuses; and
detection means for detecting a power consumption of each of said plurality of processing apparatuses,
wherein said control apparatus calculates a usable power on the basis of power consumption information of said processing apparatus detected by said detection means and power supply ability information of said power supply apparatus, and notifies said processing apparatus of the usable power.

35. The system according to claim 34, wherein said control apparatus controls said each processing apparatus on the basis of temporal change information of a power consumption corresponding to an operation order of said each processing apparatus so as to prevent a sum of power consumptions of said plurality of processing apparatuses from exceeding a power supply ability of said power supply apparatus.

36. The system according to claim 34, wherein said each processing apparatus includes a semiconductor manufacturing apparatus.

37. A control apparatus for controlling a manufacturing system having a plurality of processing apparatuses, and a power supply apparatus which supplies power to the plurality of processing apparatuses, wherein
the control apparatus detects a power consumption of each of the plurality of processing apparatuses, calculates a usable power on the basis of detected power consumption information of the processing apparatus and power supply ability information of the power supply apparatus, and notifies the processing apparatus of the usable power.

38. The apparatus according to claim 37, wherein the control apparatus controls said each processing apparatus on the basis of temporal change information of a power consumption corresponding to an operation order of said each processing apparatus so as to prevent a sum of power consumptions of the plurality of processing apparatuses from exceeding a power supply ability of the power supply apparatus.

39. The apparatus according to claim 37, wherein said each processing apparatus includes a semiconductor manufacturing apparatus.

40. A control method of controlling a manufacturing system having a plurality of processing apparatuses, and a power supply apparatus which supplies power to the plurality of processing apparatuses, comprising:
detecting a power consumption of each of the plurality of processing apparatuses;
calculating a usable power on the basis of detected power consumption information of the processing apparatus and power supply ability information of the power supply apparatus; and
notifying the processing apparatus of the usable power.

41. The method according to claim 40, wherein said each processing apparatus is controlled on the basis of temporal change information of a power consumption corresponding to an operation order of said each processing apparatus so as to prevent a sum of power consumptions of the plurality of processing apparatuses from exceeding a power supply ability of the power supply apparatus.

42. The method according to claim 40, wherein said each processing apparatus includes a semiconductor manufacturing apparatus.

43. A control program wherein the control program causes a computer to execute the control method defined in claim 40.

44. A storage medium wherein the storage medium computer-readably stores the control program defined in claim 43.

45. A manufacturing system comprising:
a plurality of processing apparatuses;
a power supply apparatus which supplies power to said plurality of processing apparatuses; and
communication means for allowing communication between said plurality of processing apparatuses,
wherein each of said plurality of processing apparatuses comprises detection means for detecting a power consumption of said processing apparatus, notification means for notifying the remaining processing apparatuses via said communication means of the detected power consumption, and control means for controlling operation of said processing apparatus on the basis of pieces of power consumption information from the remaining processing apparatuses and power supply ability information of said power supply apparatus so as to prevent a sum of power consumptions of said plurality of processing apparatuses from exceeding a power supply ability of said power supply apparatus.

46. The system according to claim 45, wherein said each processing apparatus includes a semiconductor manufacturing apparatus.

47. A control method of controlling a manufacturing system having a plurality of processing apparatuses, a power supply apparatus which supplies power to the plurality of processing apparatuses, and communication means for allowing communication between the plurality of processing apparatuses, comprising:
causing each of the plurality of processing apparatuses to detect a power consumption of the processing apparatus, to notify the remaining processing apparatuses via the communication means of the detected power consumption, and to control operation of the processing apparatus on the basis of pieces of power consumption information from the remaining processing apparatuses and power supply ability information of the power supply apparatus so as to prevent a sum of power consumptions of the plurality of processing apparatuses from exceeding a power supply ability of the power supply apparatus.

48. The method according to claim 47, wherein said each processing apparatus includes a semiconductor manufacturing apparatus.

49. A control program wherein the control program causes a computer to execute the control method defined in claim 47.

50. A storage medium wherein the storage medium computer-readably stores the control program defined in claim 49.

51. A manufacturing system comprising:
a plurality of processing apparatuses;
a utility supply apparatus which supplies a utility to said plurality of processing apparatuses; and
a control apparatus for controlling said plurality of processing apparatuses,
wherein said control apparatus creates operation schedules for said plurality of processing apparatuses on the basis of temporal change information of a utility consumption amount corresponding to an operation order of each of said plurality of processing apparatuses so as to prevent a sum of utility consumption amounts of said plurality of processing apparatuses from exceeding a utility supply ability of said utility supply apparatus.

52. A control apparatus for controlling a manufacturing system having a plurality of processing apparatuses, and a utility supply apparatus which supplies a utility to the plurality of processing apparatuses, wherein
the control apparatus creates operation schedules for the plurality of processing apparatuses on the basis of temporal change information of a utility consumption amount corresponding to an operation order of each of the plurality of processing apparatuses so as to prevent a sum of utility consumption amounts of the plurality of processing apparatuses from exceeding a utility supply ability of the utility supply apparatus.

53. A control method of controlling a manufacturing system having a plurality of processing apparatuses, and a utility supply apparatus which supplies a utility to the plurality of processing apparatuses, comprising:
creating operation schedules for the plurality of processing apparatuses on the basis of temporal change information of a utility consumption amount corresponding to an operation order of each of the plurality of processing apparatuses so as to prevent a sum of utility consumption amounts of the plurality of processing apparatuses from exceeding a utility supply ability of the utility supply apparatus; and
operating the plurality of processing apparatuses on the basis of the created operation schedules.

54. A control program wherein the control program causes a computer to execute the control method defined in claim 53.

55. A storage medium wherein the storage medium computer-readably stores the control program defined in claim 54.

56. A manufacturing system comprising:
a plurality of processing apparatuses;
a utility supply apparatus which supplies a utility to said plurality of processing apparatuses;
a control apparatus for controlling said plurality of processing apparatuses; and
detection means for detecting a utility consumption amount of each of said plurality of processing apparatuses,
wherein said control apparatus calculates a usable utility amount on the basis of utility consumption amount information of said processing apparatus detected by said detection means and utility supply ability information of said utility supply apparatus, and notifies said processing apparatus of the usable utility amount.

57. A control apparatus for controlling a manufacturing system having a plurality of processing apparatuses, and a utility supply apparatus which supplies a utility to the plurality of processing apparatuses, wherein
the control apparatus detects a utility consumption amount of each of the plurality of processing apparatuses, calculates a usable utility amount on the basis of detected utility consumption amount information of the processing apparatus and utility supply ability information of the utility supply apparatus, and notifies the processing apparatus of the usable utility amount.

58. A control method of controlling a manufacturing system having a plurality of processing apparatuses, and a utility supply apparatus which supplies a utility to the plurality of processing apparatuses, comprising:
detecting a utility consumption amount of each of the plurality of processing apparatuses;
calculating a usable utility amount on the basis of detected utility consumption amount information of the processing apparatus and utility supply ability information of the utility supply apparatus; and
notifying the processing apparatus of the usable utility amount.

59. A control program wherein the control program causes a computer to execute the control method defined in claim 58.

60. A storage medium wherein the storage medium computer-readably stores the control program defined in claim 59.

61. A manufacturing system comprising:
a plurality of processing apparatuses;
a utility supply apparatus which supplies a utility to said plurality of processing apparatuses; and
communication means for allowing communication between said plurality of processing apparatuses,
wherein each of said plurality of processing apparatuses comprises detection means for detecting a utility consumption amount of said processing apparatus, notification means for notifying the remaining processing apparatuses via said communication means of the detected utility consumption amount, and control means for controlling operation of said processing apparatus on the basis of pieces of utility consumption amount information from the remaining processing apparatuses and utility supply ability information of said utility supply apparatus so as to prevent a sum of utility consumption amounts of said plurality of processing apparatuses from exceeding a utility supply ability of said utility supply apparatus.

62. A control method of controlling a manufacturing system having a plurality of processing apparatuses, a utility supply apparatus which supplies a utility to the plurality of processing apparatuses, and communication means for allowing communication between the plurality of processing apparatuses, comprising:
causing each of the plurality of processing apparatuses to detect a utility consumption amount of the processing apparatus, to notify the remaining processing apparatuses via the communication means of the detected utility consumption amount, and to control operation of the processing apparatus on the basis of pieces of utility consumption amount information from the remaining processing apparatuses and utility supply ability information of the utility supply apparatus so as to prevent a sum of utility consumption amounts of the plurality of processing apparatuses from exceeding a utility supply ability of the utility supply apparatus.

63. A control program wherein the control program causes a computer to execute the control method defined in claim 62.

64. A storage medium wherein the storage medium computer-readably stores the control program defined in claim 63.
